(19) United States
(12) Patent Application Publication
(10) Pub. No.: US 2017/0009941 A1
(43) Pub. Date: Jan. 12, 2017

(54) Modular Light Emitting Diode Lamp Fixture

(71) Applicant: Pixon Technologies Corp., New Taipei City (TW)

(72) Inventor: Yen-Chieh CHEN, New Taipei City (TW)

(21) Appl. No.: 14/795,737

(22) Filed: Jul. 9, 2015

(51) Int. Cl. F21K 99/00; F21V 23/04; F21V 33/00; F21V 29/70

(52) U.S. Cl. CPC F21K 9/17; F21V 29/70; F21V 23/04; F21V 33/0056; F21Y 2103/003

(57) ABSTRACT

A modular light emitting diode (LED) lamp fixture comprising a weighted lamp base, a vertical lamp post, and a light pipe assembly is disclosed. A light pipe in the light pipe assembly converts spot light emitted from LED chips into a linear light source. Audio connectors are provided to electrically couple the lamp base, the lamp post, and the light pipe assembly. Using audio connectors as electrical connectors allow the light pipe assembly and the lamp post to be rotated. The audio connectors allow easy changing of the light pipe assembly size and the lamp post length. A top cover of the light pipe assembly provides a main heat dissipating unit. Heat sinks are in contact with heat pipes which transfer heat quickly away from the LED chips of the light pipe assembly. The heat pipes are in turn in close contact with the top cover.

### BACKGROUND OF THE INVENTION

Field of the Invention

The present invention relates to lighting fixtures. More specifically, the present invention discloses a modular free-standing light emitting diode lamp fixture that is flexible in structural arrangement and energy efficient.

Description of the Prior Art

Conventional lighting fixtures are used to illuminate a room or a portion of a room. One type of lighting fixture is a lamp which is moveable to light up different areas of a room. While convenient, the conventional lamp fixture has several disadvantages.

One disadvantage of the conventional lamp fixture is that the size and structural arrangement is fixed. Once assembled alterations to the lamp fixture cannot be made other than changing the light bulb. As a result a consumer must purchase separate lamp fixtures for each specific application. For example, a desk lamp must be purchase for use on a desk, a table lamp must be purchased for use on a table, and a standing lamp must be purchased for use in a corner of a room. None of these lamp fixture types are interchangeable or adaptable for other uses.

Further inhibiting adaptability of the conventional lamp fixture is that a power cord extends from the plug and through the lamp and connects to the light bulb fixture. Any attempt to alter the lamp fixture is prevented by limitations of the fixed power cord.

Another disadvantage of the conventional lamp is the light bulb which emits light. Incandescent bulbs are not energy efficient, radiate heat, are easily damaged from contact, and have a short lifespan. Florescent bulbs are relatively expensive, often flicker, and are not environmentally friendly as the potentially dangerous chemicals used inside the bulb make it difficult to safely dispose of the bulb in an eco-friendly manner.

Therefore, there is need for an improved lamp fixture that is easily adaptable to change the size and structure of the lamp while providing an energy efficient light source.

### SUMMARY OF THE INVENTION

To achieve these and other advantages and in order to overcome the disadvantages of the conventional methods in accordance with the purpose of the invention as embodied and broadly described herein, the present invention provides a modular free-standing light emitting diode lamp fixture that is flexible in structural arrangement and energy efficient.

The modular light emitting diode (LED) lamp fixture of the present invention comprises a lamp base, a lamp post, and a light pipe assembly.

The lamp base provides a weighted base structure for stability of the modular LED lamp fixture.

The lamp post provides a vertical structure between the lamp base and the light pipe assembly. The length of a lamp post tube of the lamp post determines the vertical height of the modular LED lamp fixture.

The light pipe assembly provides the light source for the modular LED lamp fixture. A light pipe in the light pipe assembly provides a light guide for converting spot light emitted from LEDs of a printed circuit board (PCB) into a linear light source for the modular LED lamp fixture.

Audio connectors are provided to electrically couple the lamp base, the lamp post, and the light pipe assembly. Using audio connectors as electrical connectors allow the light pipe assembly to be rotated and the lamp post to be rotated. In this way, the emitted light can be redirected to illuminate desired areas without moving the entire lamp fixture.

Additionally, the audio connectors allow for easy changing of the light pipe assembly length or size and the lamp post length. The present invention provides a modular LED lamp fixture with flexibility in structure and architecture. For example, if a desk lamp is desired a relatively short lamp post is interchanged to produce an LED lamp fixture with the light source closer to the desk. If a standing lamp is desired a longer lamp post is interchanged so that the light source is higher off the ground.

Also, for example, if a larger light source to illuminate a larger area is desired a longer light pipe assembly is easily interchanged. Interchanging the light pipe assembly also allows light sources with a variety of color temperatures, number of LEDs, and color changing mechanism to be provided.

The present invention also utilizes superior heat sinking technology. The top cover of the light pipe assembly provides a main heat dissipating unit that interacts with the surroundings. Heat transfer via convection and radiation is effective. The primary heat sinks are in contact with heat pipes which transfers or pulls heat quickly away from the cluster of LEDs on the PCB of the light pipe assembly. The heat pipes are in turn in close contact with the top cover which acts as the main heat dissipating unit.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is drawing illustrating a modular light emitting diode lamp fixture according to an embodiment of the present invention;

FIG. 1B is an exploded view drawing illustrating a modular light emitting diode lamp fixture according to an embodiment of the present invention;

FIG. 2A is a drawing illustrating a lamp base of a modular light emitting diode lamp fixture according to an embodiment of the present invention;

FIG. 2B is a drawing illustrating an interior of a lamp base of a modular light emitting diode lamp fixture according to an embodiment of the present invention;

FIG. 2C is an exploded view drawing illustrating a lamp base of a modular light emitting diode lamp fixture according to an embodiment of the present invention;

FIG. 3A is a drawing illustrating a lamp post of a modular light emitting diode lamp fixture according to an embodiment of the present invention;

FIG. 3B is an exploded view drawing illustrating a lamp post of a modular light emitting diode lamp fixture according to an embodiment of the present invention;

FIG. 4A is a drawing illustrating a light pipe assembly of a modular light emitting diode lamp fixture according to an embodiment of the present invention;

FIG. 4B is an exploded view drawing illustrating a light pipe assembly of a modular light emitting diode lamp fixture according to an embodiment of the present invention;

FIG. 4C is a drawing illustrating a main chassis with packages of a light pipe assembly according to an embodiment of the present invention;

FIG. 4D is an exploded view drawing illustrating a main chassis with light pipe and packages of a light pipe assembly according to an embodiment of the present invention;

FIG. 4E is a drawing illustrating a light pipe with light scattering pattern of a light pipe assembly according to an embodiment of the present invention;

FIG. 4F is an end view drawing illustrating a light pipe of a light pipe assembly according to an embodiment of the present invention;

FIG. 4G is a cross-section view drawing illustrating a light pipe with light scattering pattern of a light pipe assembly according to an embodiment of the present invention;

FIG. 4H is a drawing illustrating a main chassis with packages and heat sinks of a light pipe assembly according to an embodiment of the present invention;

FIG. 4I is a drawing illustrating heat pipes and heat sinks of a light pipe assembly according to an embodiment of the present invention;

FIG. 4J is an exploded view drawing illustrating heat pipes and heat sinks of a light pipe assembly according to an embodiment of the present invention;

FIG. 4K is a drawing illustrating a PCB with LED chips of a light pipe assembly according to an embodiment of the present invention;

FIG. 4L is a side view drawing illustrating a PCB with LED chips of a light pipe assembly according to an embodiment of the present invention; and

FIG. 4M is a drawing illustrating components of a light pipe assembly according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

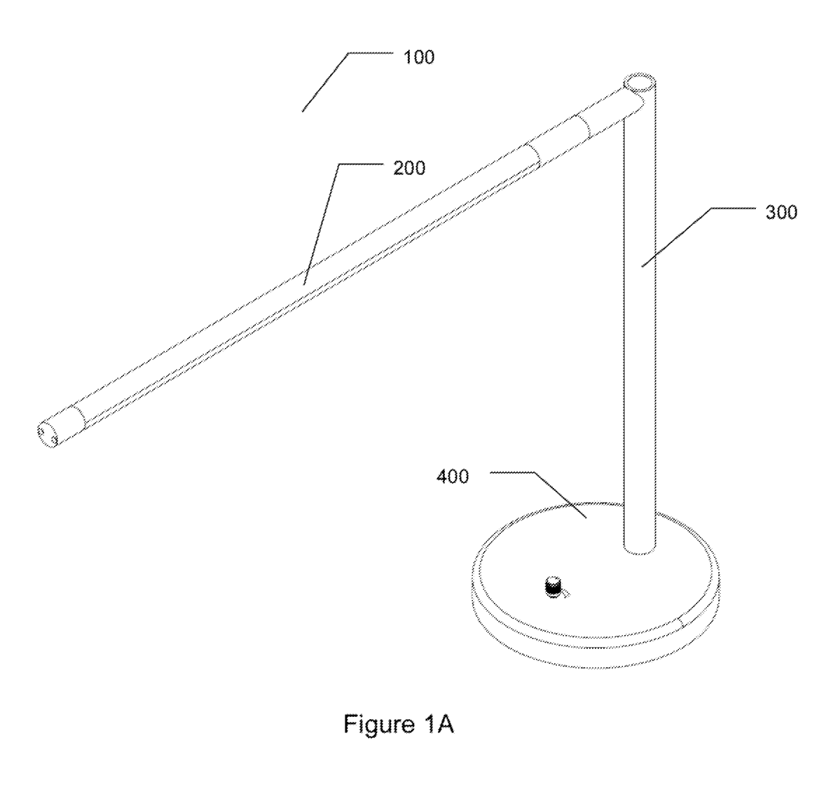

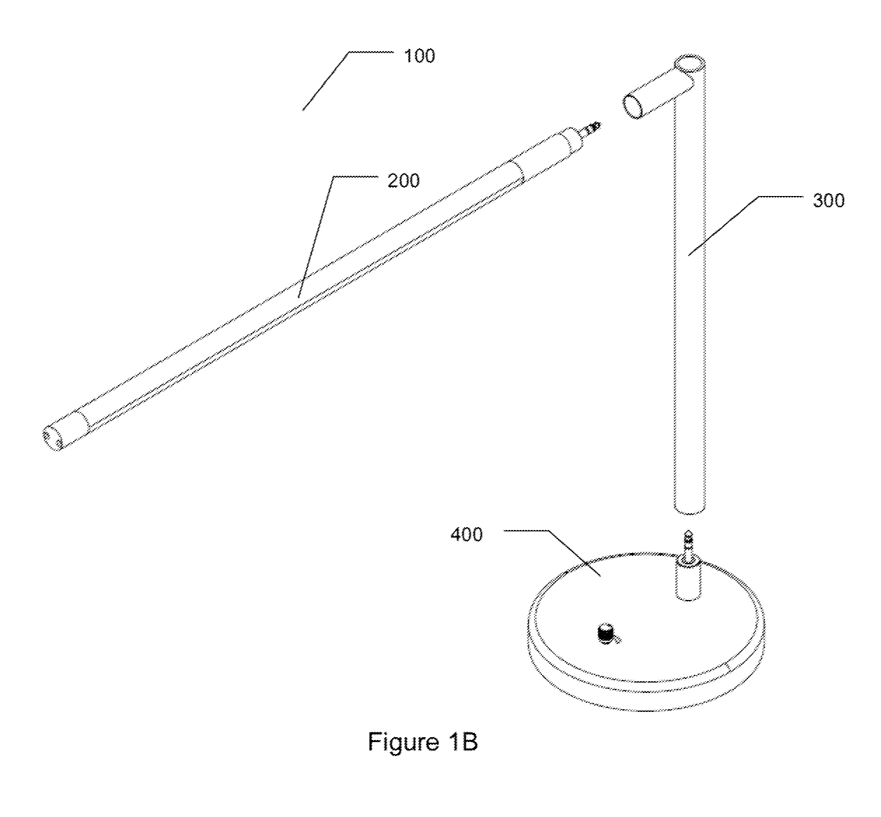

Refer to FIG. 1A, which is drawing illustrating a modular light emitting diode lamp fixture according to an embodiment of the present invention and refer to FIG. 1B, which is an exploded view drawing illustrating a modular light emitting diode lamp fixture according to an embodiment of the present invention.

The modular light emitting diode (LED) lamp fixture 100 of the present invention comprises a lamp base 400, a lamp post 300, and a light pipe assembly 200.

The lamp base 400 provides a weighted base structure for the modular LED lamp fixture 100.

The lamp post 300 provides a vertical structure and electrical connection between the lamp base 400 and the light pipe assembly 200. The length of the lamp post 300 determines the how far the light pipe assembly 200 is away from the surface that the lamp base 400 is seated on.

The light pipe assembly 200 provides the light source for the modular LED lamp fixture 100.

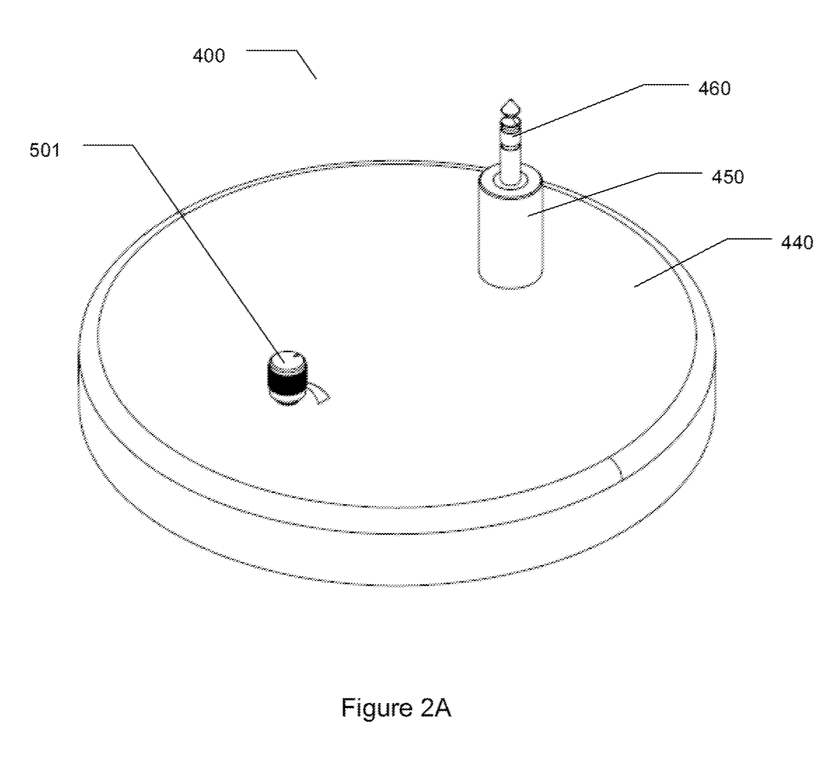

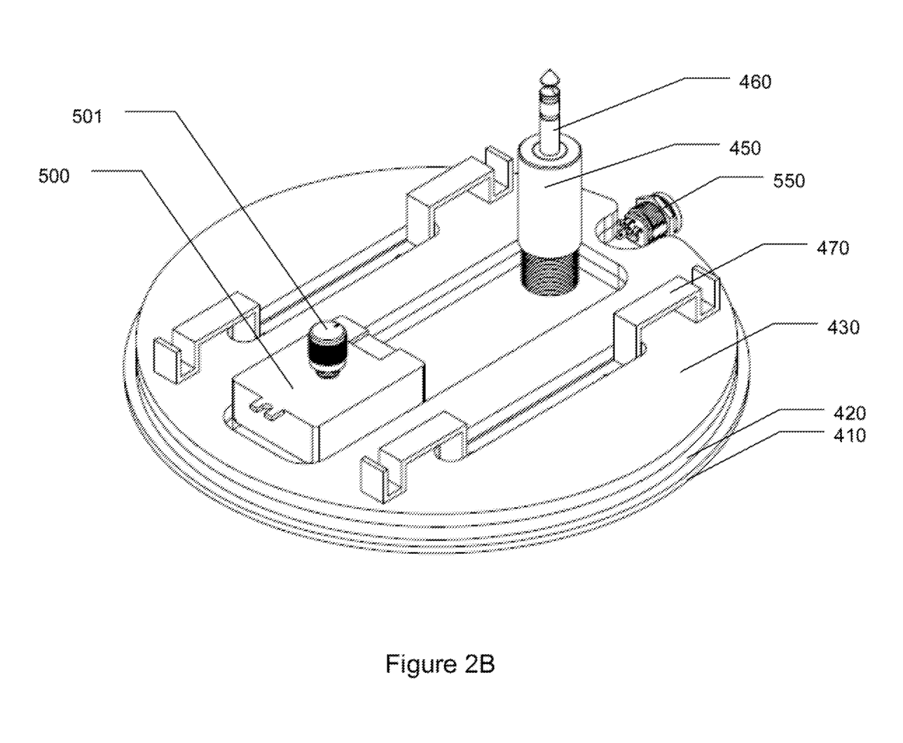

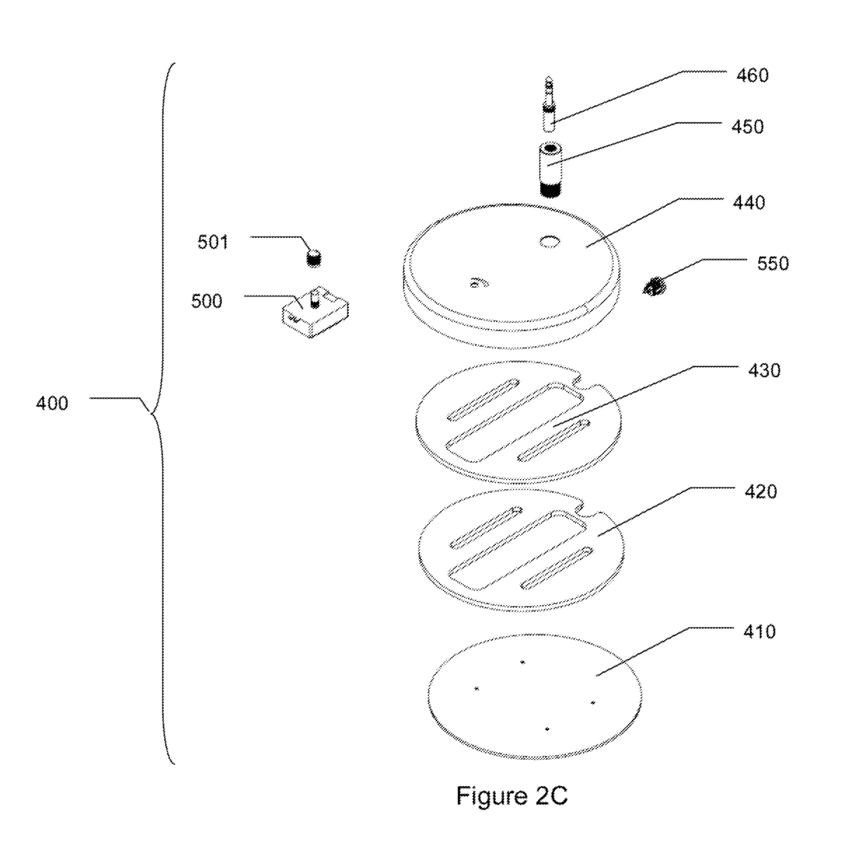

Refer to FIG. 2A, which is a drawing illustrating a lamp base of a modular light emitting diode lamp fixture according to an embodiment of the present invention and refer to FIG. 2B, which is a drawing illustrating an interior of a lamp base of a modular light emitting diode lamp fixture according to an embodiment of the present invention and refer to FIG. 2C, which is an exploded view drawing illustrating a lamp base of a modular light emitting diode lamp fixture according to an embodiment of the present invention.

The lamp base 400 comprises a first base weight 430 and a second base weight 420 disposed in a base cover 440. A plate cover 410 attaches to the base cover 440 to hold the first base weight 430 and the second base weight 420 inside the base cover 440. The lamp base 400 further comprises a base audio connector 460 for providing electrical power to the lamp post. A base audio connector base 450 connects the base audio connector 460 to the base cover 440.

In the embodiment illustrated in FIG. 2C two base weights (first base weight 430 and second base weight 420) are provided to add stabilization to the LED lamp fixture. However, in other embodiments of the present invention a single weight is provided or more than two weights are provided to add stabilization to the LED lamp fixture.

A power connector 550 is provided to connect with a power source to allow power to be supplied to the modular light emitting diode lamp fixture.

An on/of dimmer switch 500 allows a user to turn on, turn off, and control the brightness of the modular light emitting diode lamp fixture by turning a switch knob 501 of the on/off dimmer switch.

The power connector 550 is electrically coupled to the on/off dimmer switch 500 and the on/off dimmer switch 500 is electrically coupled to the base audio connector 460.

A pair of retainers 470 are provided to maintain positioning of the weight or weights inside the base cover 440.

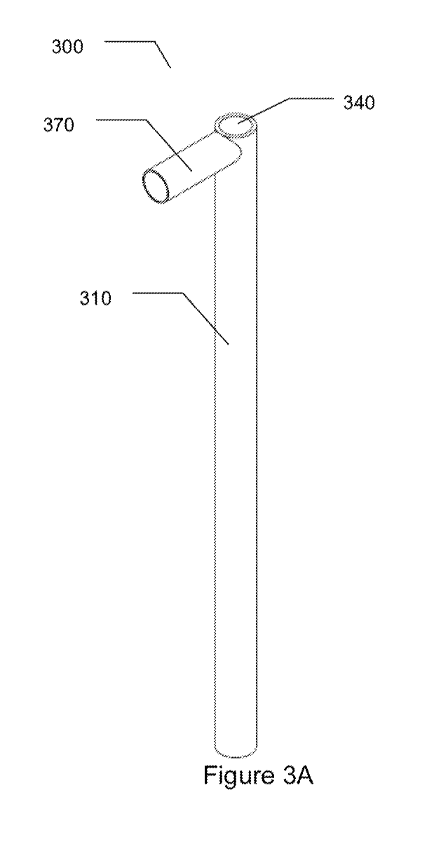

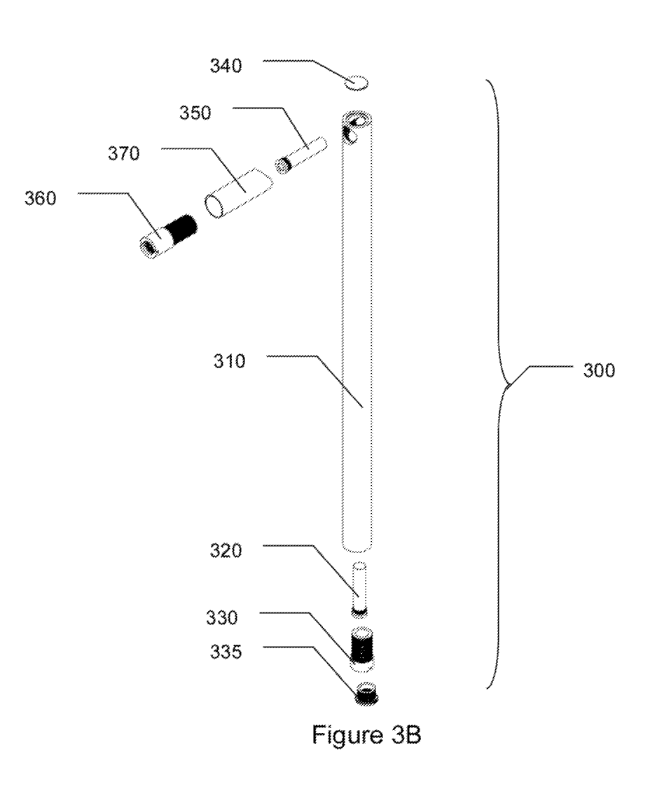

Refer to FIG. 3A, which is a drawing illustrating a lamp post of a modular light emitting diode lamp fixture according to an embodiment of the present invention and refer to FIG. 3B, which is an exploded view drawing illustrating a lamp post of a modular light emitting diode lamp fixture according to an embodiment of the present invention.

The lamp post 300 comprises a lower post audio connector 320 disposed on a bottom end of a lamp post tube 310 for connecting with the base audio connector of the lamp base. An upper post audio connector 350 is perpendicularly disposed near the other end of the lamp post tube 310 for connecting with a light audio connector of the light pipe assembly.

A connector tube 370 connected to the lamp post tube 310 is provided to cover the upper post audio connector 350.

An upper audio connector base 360 connects the upper audio connector 350 to the lamp post tube 310. A lower audio connector base 330 and a lower audio connector seat 335 connect the lower audio connector 320 to the lamp post tube 310.

The lower audio connector 320 and the upper audio connector 350 are electrically connected by, for example, flexible wiring. When electrical power is applied to the lower audio connector 320 from the base audio connector of the lamp base, the electrical power is provided to the upper audio connector 350.

A round cover 340 is provided to cover the open end of the lamp post tube 310.

The length of the lamp post tube 310 of the lamp post 300 determines the vertical height of the modular LED lamp fixture. Utilizing a shorter lamp post tube 310 provides a desk or table lamp. Utilizing a longer lamp post tube 310 provides a standing lamp or room corner lamp.

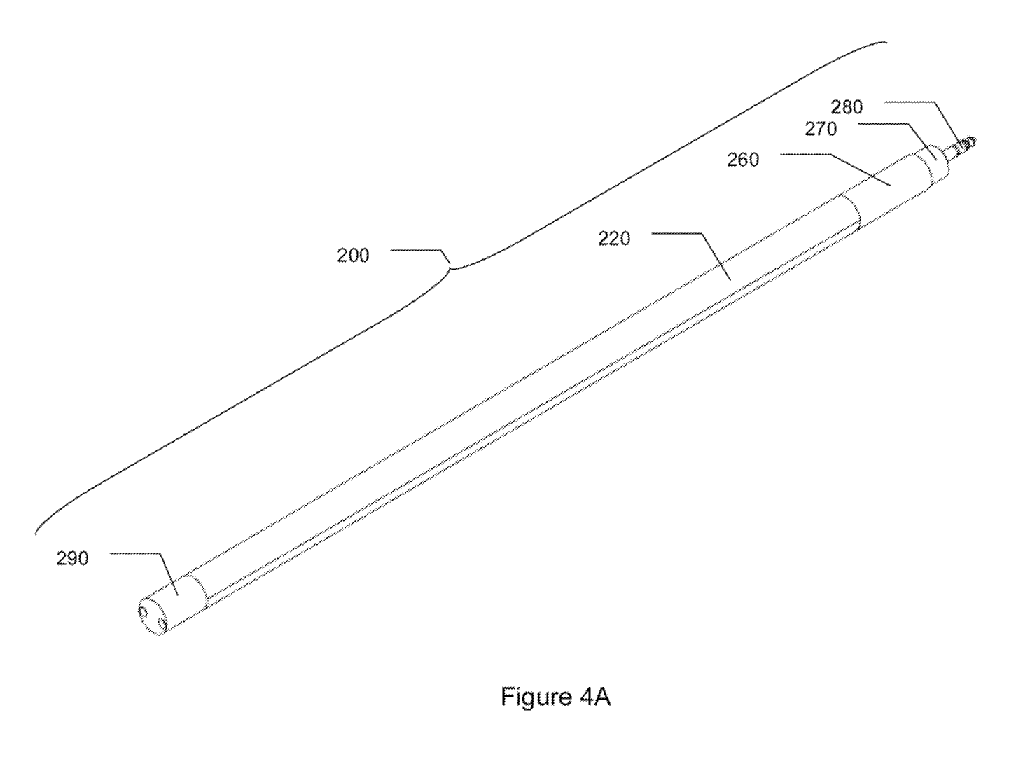

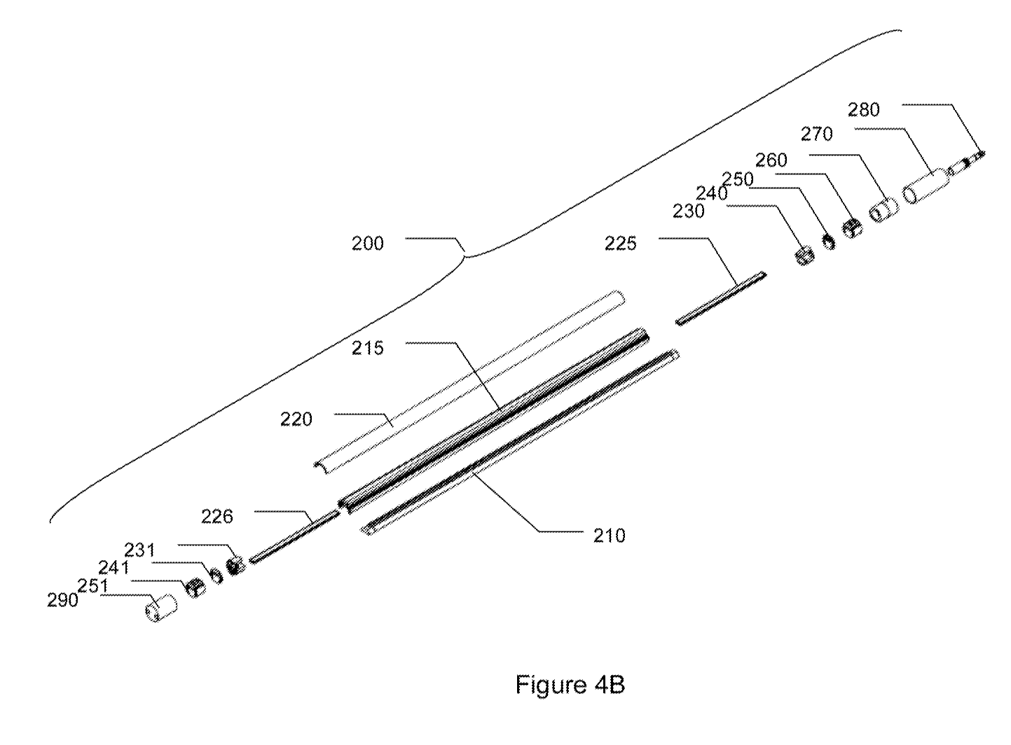

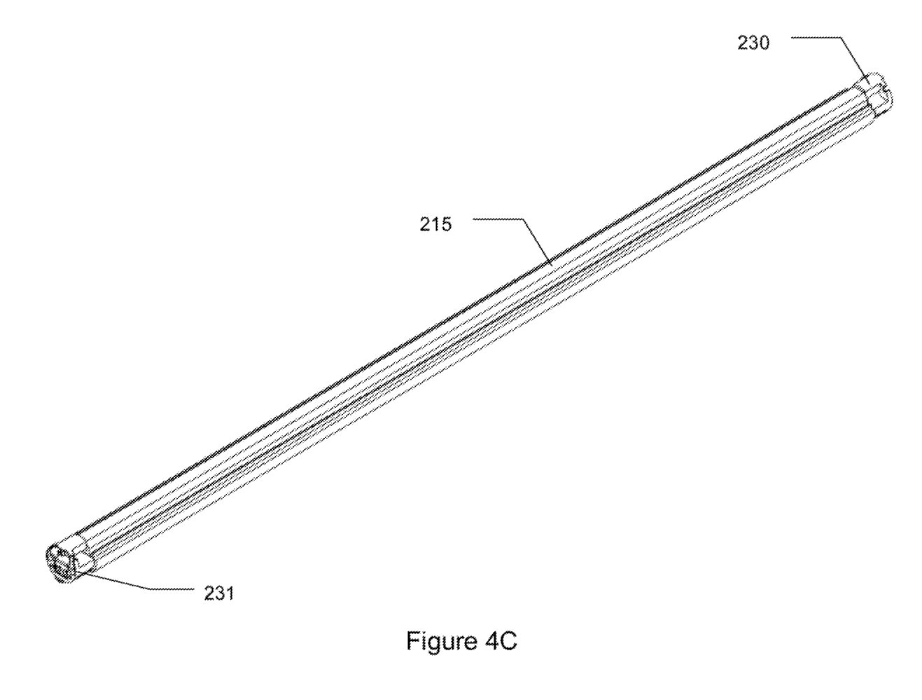

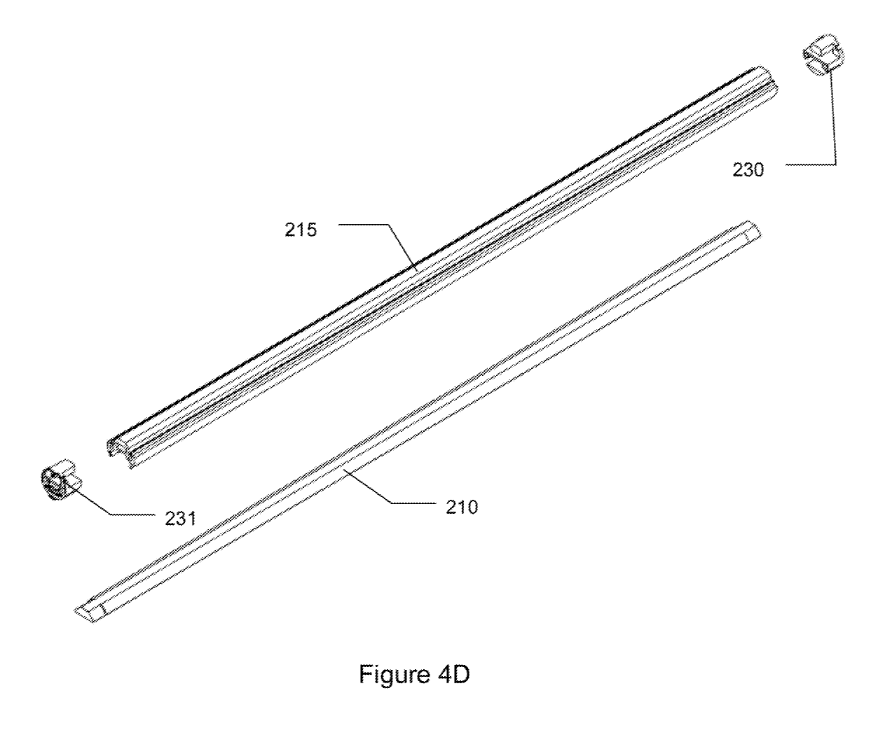

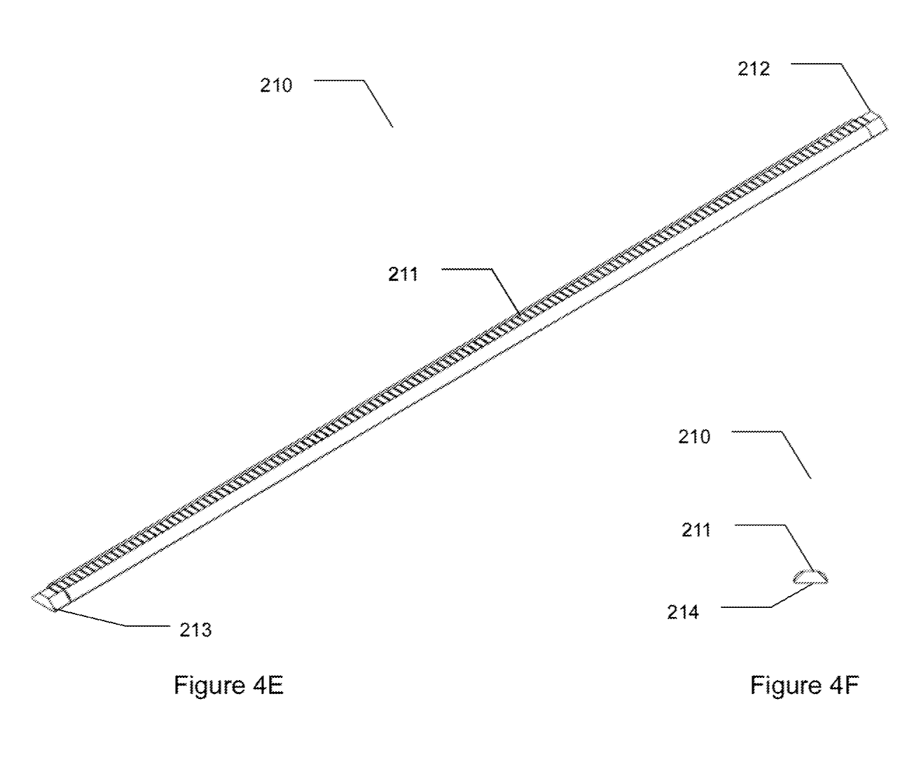

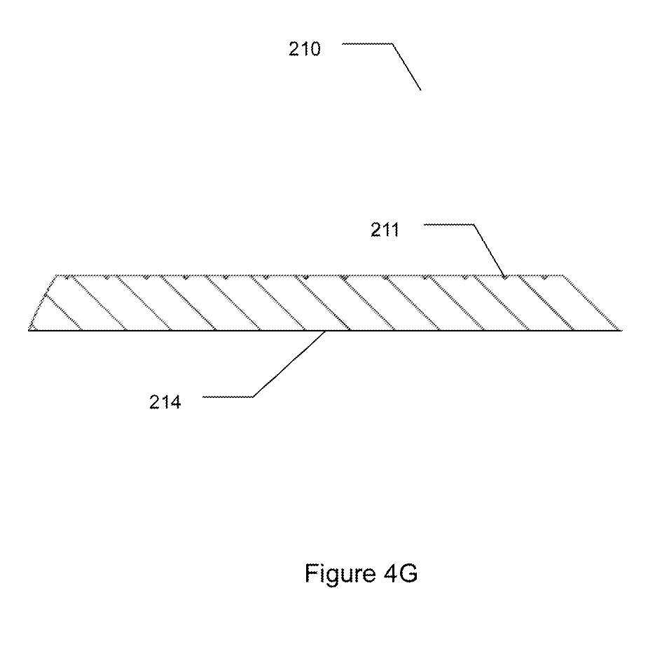

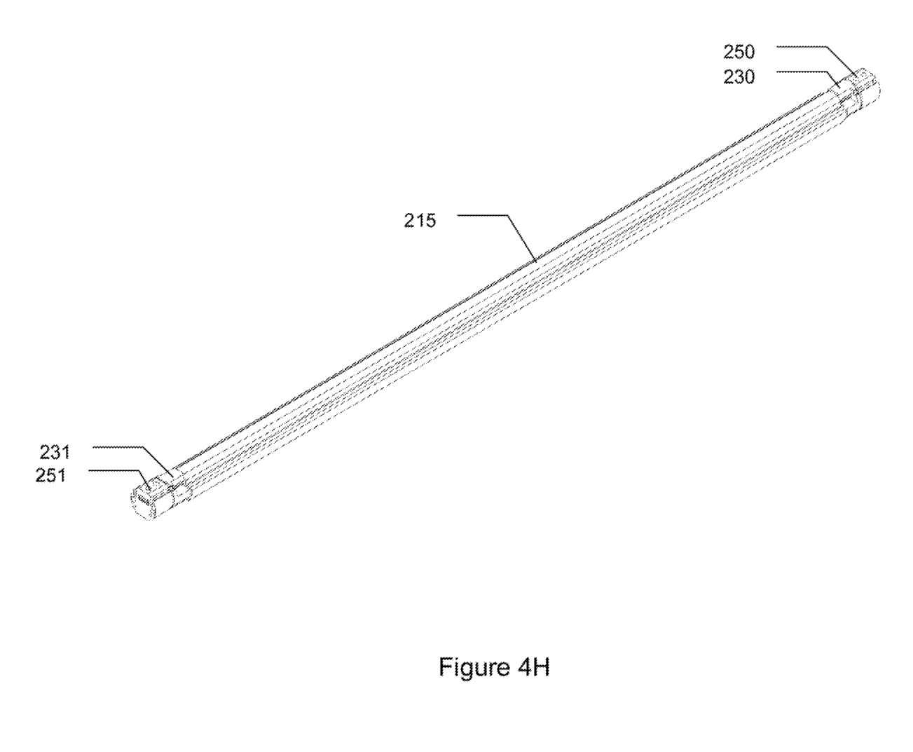

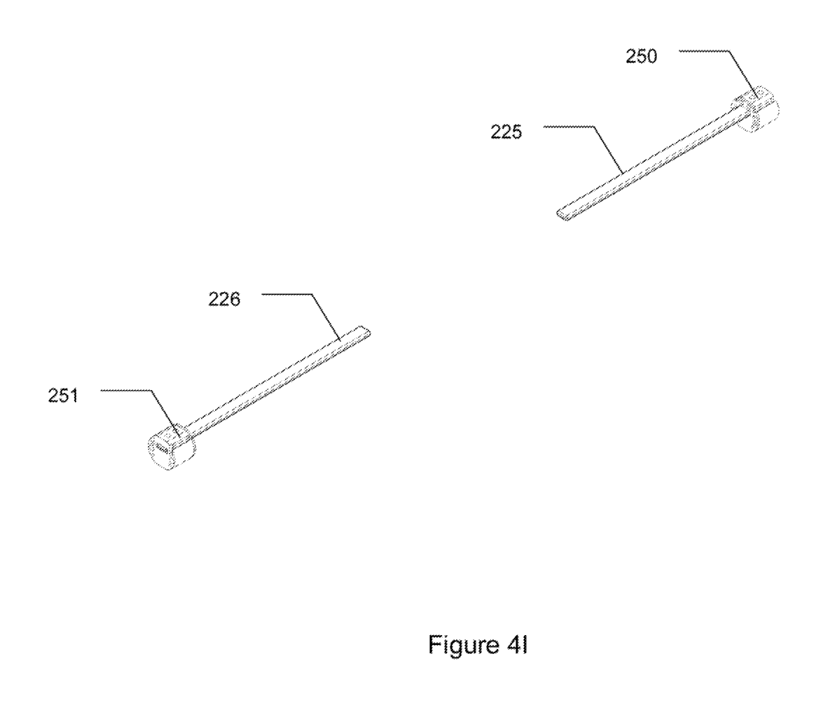

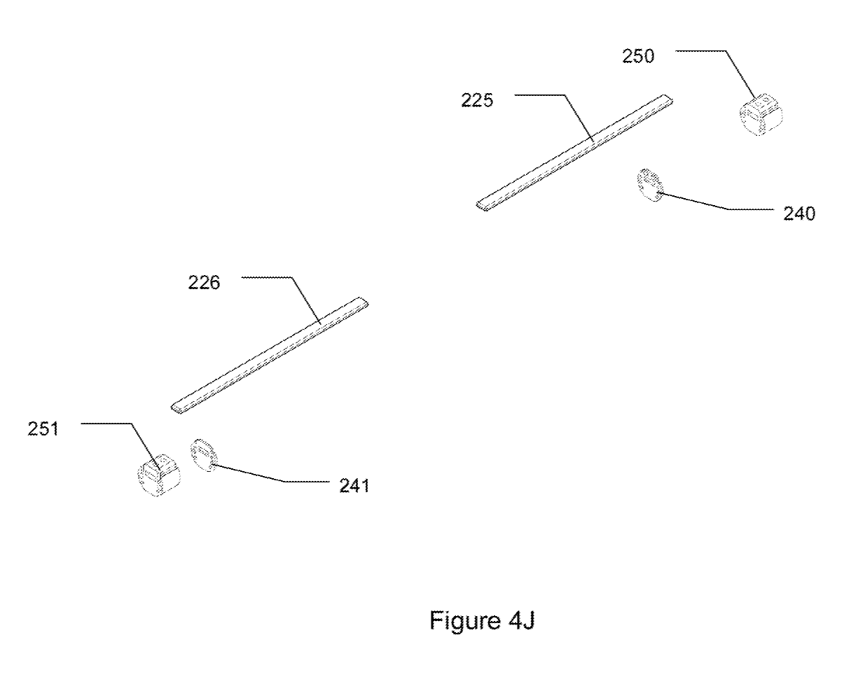

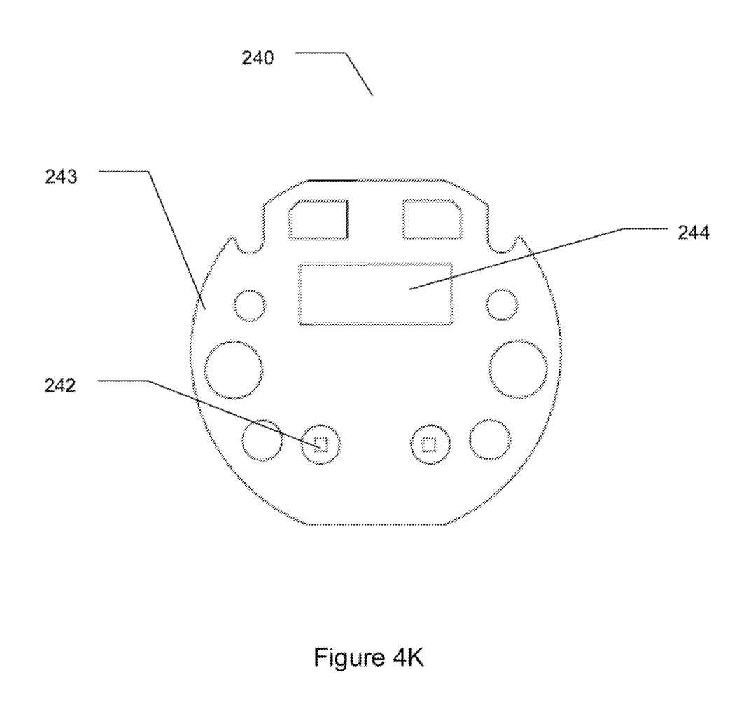

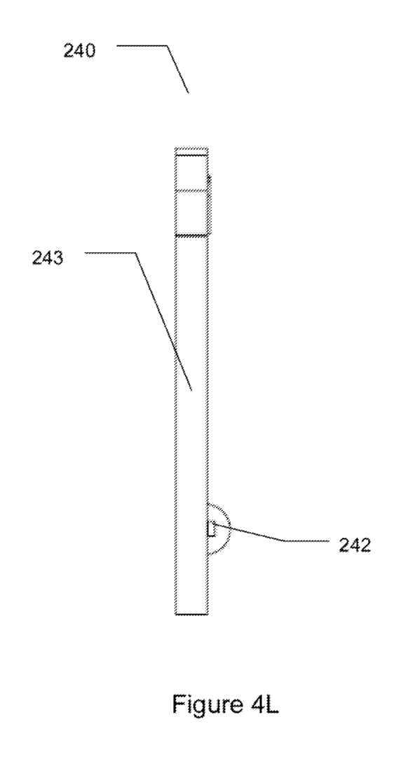

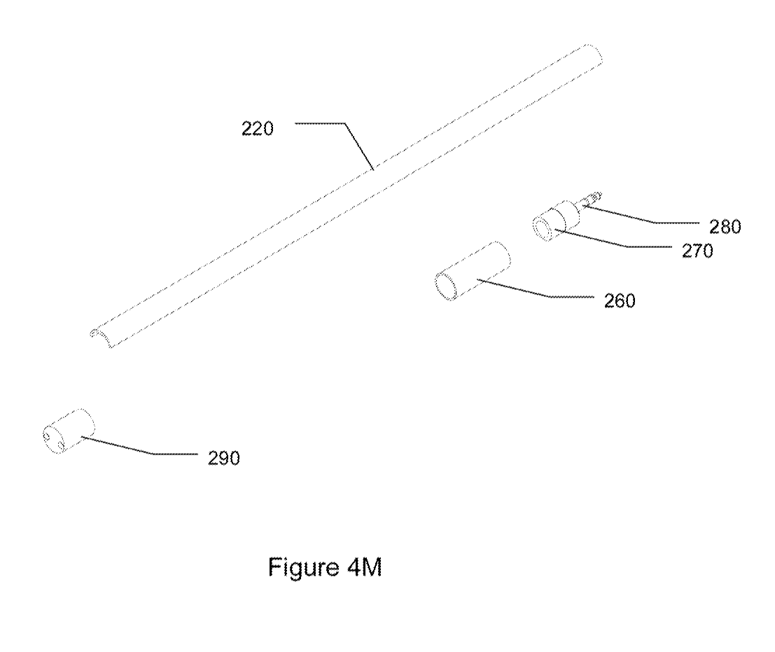

Refer to FIGS. 4A-4M which are drawings illustrating a light pipe assembly and components of a light pipe assembly of a modular light emitting diode lamp fixture according to embodiments of the present invention.

The light pipe assembly 200 comprises a main chassis 215 for providing a main body to the light pipe assembly 200. A top cover 220 is disposed on top of the main chassis 215. A light pipe 210 in the main chassis 215 provides a light guide for converting spot light emitted from LED chips 242 of the PCBs 240 241 into a linear light source for the modular LED lamp fixture.

The light pipe 210 comprises a light scattering pattern 211 disposed on a surface of the light pipe 210 opposite a light emission surface 214. The light scattering pattern 211 comprises a plurality of notches formed in the top surface of the light pipe 210.

The light pipe 210 further comprises a light pipe front end 212 and a light pipe rear end 213.

When assembled the light pipe 210 is disposed in a bottom opening of the main chassis 215. The front package 230 is disposed on the light pipe front end 212 and the rear package 231 is disposed on the light pipe rear end 213. The front PCB 240 is disposed on the front package 230 and the rear PCB 241 is disposed on the rear package 231.

When power is supplied to the front PCB 240, LED chips 242 on the front PCB 240 turn on and emit light. The light then travels through openings in the front package 230 and enters the light pipe front end 212 of the light pipe 210.

When power is supplied to the rear PCB 241, LED chips 242 on the rear PCB 241 turn on and emit light. The light then travels through openings in the rear package 231 and enters the light pipe rear end 213 of the light pipe 210.

After the light enters the light pipe front end 212 and the light pipe rear end 213 the light travels through the light pipe 210 and exits the light emission surface 214 or is scattered or diffused by the light scattering pattern 211 and reflected and exits from the light emission surface 214.

A front heat pipe 225 is disposed in a cavity on the front end of the main chassis 215 and a rear heat pipe 225 is disposed in the cavity on the rear end of the main chassis 215.

Disposed on the front end of the top cover 220, main chassis 215, and light pipe 210 are a front package 230, a front printed circuit board (PCB) 240, a front heat sink 250, a light audio connector base 270, and a light audio connector 280. A sleeve 260 surrounds the front package 230, the front PCB 240, and the front heat sink 250 and connects with the light audio connector base 270. Fasteners travel through the front package 230, the front PCB 240, and the front heat sink 250 and attach to the main chassis 215.

Disposed on the rear end of the top cover 220, main chassis 215, and light pipe 210 are a rear package 231, a rear PCB 241, and a rear heat sink 251. An end cover 290 provides a cover for the rear package 231, the rear PCB 241, and the rear heat sink 251. Fasteners travel through openings in the end cover 290, the rear package 231, the rear PCB 241, and the rear heat sink 251 and attach to the main chassis 215.

In addition to being disposed partially into the cavity of the main chassis 215, a front end of the front heat pipe 225 is inserted into an opening in the front package 230, a PCB hole 244 of the PCB 240, and the front heat sink 250 and a rear end of the rear heat pipe 226 is inserted into an opening in the rear package 231, a PCB hole in the rear PCB 241, and the rear heat sink 251. This allows heat generated by the LED chips 242 on the substrate 243 of the PCBs 240 241 to be transferred away quickly by the heat sinks 250 251, the heat pipes 225 226, and the main chassis 215 and radiated by the top cover 220.

Electrical connections couple the rear PCB 241, the front PCB 240, and the light audio connector 280. When the light audio connector 280 is connected to the upper audio connector of the lamp post, electrical power can be made available to the rear PCB 241 and the front PCB 240 via the light audio connector 280.

Refer to all the figures for clarity of the following description.

In application, the light pipe assembly 200, the lamp post 300, and the lamp base 400 are individually assembled during manufacturing. Due to the three main individual components, efficiency of packaging and shipping of the modular LED lamp fixture 100 is increased.

After unpacking, the modular LED lamp fixture 100 is easily assembled by connecting the base audio connector 460 and the lower audio connector 320 together and connecting the upper audio connecter 350 and the light audio connector 280 together.

As described, assembling the modular LED lamp fixture 100 requires only two simple steps and doesn't require any tools. The simplicity of assembly is an advantage of the present invention.

After the modular LED lamp fixture 100 has been assembled, electrical power is applied to the lamp base 400 via the power connector 550. When the modular LED lamp fixture 100 has been turned on, the electrical power travels from the base audio connector 460 to the lower audio connector 320 to the upper audio connector 350 and to the light audio connector 280 and the electrical power is available to the rear PCB 241 and the front PCB 240. When power is applied to the LED chips 242 of the rear PCB and the front PCB 240, the LED chips 242 turn on and emit light into the light pipe rear end 213 and the light pipe front end 212 of the light pipe 210. The light travels through the light pipe 210 and is diffused by the light scattering pattern 211 and emitted from the light emitting surface 214 of the light pipe 210.

Since the light pipe assembly is connected to the lamp post by an audio connector, the light pipe assembly can be easily rotated to position the emitted light to illuminate a desired area.

Also, an alternative light pipe assembly can be easily interchanged by disconnecting the light audio connector from the lamp post and connecting the light audio connecter of the new light pipe assembly to the lamp post.

Additionally, the height of the modular LED lamp fixture can easily be changed by interchanging a new lamp post of a different length by disconnecting the upper and lower audio connectors and connecting the upper and lower audio connectors of the new lamp post.

In an embodiment of the present invention the light audio connector is a male connector, the upper audio connector is a female connector, the lower audio connector is a female connector, and the base audio connector is a male connector.

In another embodiment of the present invention the light audio connector is a female connector, the upper audio connector is a male connector, the lower audio connector is a male connector, and the base audio connector is a female connector.

In an embodiment of the present invention the audio connectors are ¼ inch stereo audio connectors.

In another embodiment of the present invention the audio connectors are mini stereo audio connectors.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A modular light emitting diode lamp fixture comprising:
a lamp base comprising:
a weighted base comprising a base audio connector;
a lamp post comprising:
a lamp post tube;
a lower audio connector attached to the lamp post tube and connected to the base audio connector; and
an upper audio connector attached to the lamp post tube, the upper audio connector electrically coupled to the lower audio connector; and
a light pipe assembly comprising:
a light pipe disposed in a main chassis;
at least one light emitting diode for emitting light into the light pipe;
at least one heat sink for transferring heat away from the at least one light emitting diode; and
a light audio connector disposed on a front end of the main chassis and connected to the upper audio connector.

2. The modular light emitting diode lamp fixture of claim 1, the light pipe assembly further comprising:
at least one heat pipe partially inserted into the main chassis, the at least one heat pipe contacting the at least one heat sink.

3. A modular light emitting diode lamp fixture comprising:
a lamp base comprising:
a weighted base; and
a base audio connector connected to the weighted base;
a lamp post comprising:
lamp post tube;
a lower audio connector connected to the lamp post tube and connected to the base audio connector; and
an upper audio connector connected to the lamp post tube, the upper audio connector electrically coupled to the lower audio connector; and
a light pipe assembly comprising:
a main chassis;
a light pipe disposed in the main chassis, the light pipe comprising a light scattering pattern;
at least one light emitting diode for emitting light into the light pipe;
at least one heat pipe partially inserted into the main chassis;
at least one heat sink contacting the at least one heat pipe; and
a light audio connector disposed on a front end of the main chassis and connected to the upper audio connector.

4. The modular light emitting diode lamp fixture of claim 3,further comprising:
a top cover disposed on the main chassis.

5. The modular light emitting diode lamp fixture of claim 3, where the at least one light emitting diode is electrically coupled to the light audio connector.

6. The modular light emitting diode lamp fixture of claim 3, further comprising:
at least one printed circuit board electrically coupled to the at least one light emitting diode and the light audio connector.

7. The modular light emitting diode lamp fixture of claim 3, the light base further comprising:
a dimmer switch electrically coupled to the base audio connector.

8. The modular light emitting diode lamp fixture of claim 7, the light base further comprising:
a power connector electrically coupled to the dimmer switch.

9. The modular light emitting diode lamp fixture of claim 3, the weighted base comprising:
a base cover;
at least one base weight disposed in the base cover; and
a plate cover attached to the base cover for holding the at least one base weight inside the base cover.

10. The modular light emitting diode lamp fixture of claim 3, the light pipe assembly further comprising:
an end cover disposed on a rear end of the main chassis.

11. The modular light emitting diode lamp fixture of claim 3, the light pipe assembly further comprising:
a sleeve disposed on the front end of the main chassis and surrounding a portion of the light audio connector.

12. The modular light emitting diode lamp fixture of claim 3, the base audio connector comprising a male stereo audio jack, the lower audio connector comprising a female stereo audio socket, the upper audio connector comprising a female stereo audio socket, and the light audio connector comprising a male stereo audio jack.

13. The modular light emitting diode lamp fixture of claim 3, the base audio connector comprising a female stereo audio jack, the lower audio connector comprising a male stereo audio socket, the upper audio connector comprising a male stereo audio socket, and the light audio connector comprising a female stereo audio jack.

14. The modular light emitting diode lamp fixture of claim 3, the base audio connector, the lower audio connector, the upper audio connector, and the light audio connector comprising ¼ inch stereo audio connectors.

15. The modular light emitting diode lamp fixture of claim 3, the base audio connector, the lower audio connector, the upper audio connector, and the light audio connector comprising mini stereo audio connectors.

16. A modular light emitting diode lamp fixture comprising:
a lamp base comprising:
a base cover;
a first base weight:
a second base weight, the first base weight and the second weight disposed in the base cover;
a plate cover attached to the base cover for holding the first base weight and the second base weight inside the base cover;
a base audio connector base connected to the base cover;
a base audio connector connected to the base audio connector base;
a dimmer switch electrically coupled to the base audio connector; and
a power connector electrically coupled to the dimmer switch;
a lamp post comprising:
a lamp post tube;
a lower audio connector base disposed on a bottom end of the lamp post tube;
a lower audio connector connected to the lower audio connector base, the lower audio connector connecting with the base audio connector of the lamp base;
an upper audio connector base perpendicularly disposed near a top end of the lamp post tube;
an upper audio connector connected to the upper audio connector base, the upper audio connector electrically coupled to the lower audio connector;
a connector tube connected to the upper audio connector base; and
a round cover disposed on the top end of the lamp post tube; and
a light pipe assembly comprising:
a main chassis for providing a main body to the light pipe assembly;
a top cover disposed on top of the main chassis;
a light pipe disposed in an opening of the main chassis for providing a light guide for converting spot light into a linear light source, the light pipe comprising a plurality of notches disposed on a surface opposite a light emission surface;
a front heat pipe disposed in a cavity on a front end of the main chassis
a rear heat pipe disposed in the cavity on a rear end of the main chassis;
a rear package;
a rear printed circuit board connected to the rear package, the rear printed circuit board comprising at least one rear light emitting diode;
a rear heat sink;
the rear package, the rear printed circuit board, and the rear heat sink disposed on the rear end of the main chassis;
an end cover connected to the rear end of the main chassis covering the rear package, the rear printed circuit board, and the rear heat sink;
a front package;
a front printed circuit board connected to the front package, the front printed circuit board comprising at least one front light emitting diode;
a front heat sink;
the front package, the front printed circuit board, and the front heat sink disposed on the front end of the main chassis;
a sleeve connected to the front end of the main chassis surrounding the front package, the front printed circuit board, and the front heat sink;
a light audio connector base connected to the sleeve; and
a light audio connector connected to the light audio connector base, the light audio connector electrically coupled to the front printed circuit board and the rear printed circuit board, and the light audio connector connecting with the upper audio connector of the lamp post.

17. The modular light emitting diode lamp fixture of claim 16, the base audio connector comprising a male stereo audio jack, the lower audio connector comprising a female stereo audio socket, the upper audio connector comprising a female stereo audio socket, and the light audio connector comprising a male stereo audio jack.

18. The modular light emitting diode lamp fixture of claim 16, the base audio connector comprising a female stereo audio jack, the lower audio connector comprising a male stereo audio socket, the upper audio connector comprising a male stereo audio socket, and the light audio connector comprising a female stereo audio jack.

19. The modular light emitting diode lamp fixture of claim 16, the base audio connector, the lower audio connector, the upper audio connector, and the light audio connector comprising ¼ inch stereo audio connectors.

20. The modular light emitting diode lamp fixture of claim 16, the base audio connector, the lower audio connector, the upper audio connector, and the light audio connector comprising mini stereo audio connectors.
